(19) United States
(12) Patent Application Publication
(10) Pub. No.: US 2006/0166984 A1
(43) Pub. Date: Jul. 27, 2006

(54) Amino substituted benzo(hetero)cyclic derivatives

(76) Inventors: Gerd Steiner, Kirchheim (DE); Thomas Schmidt, Neustadt (DE); Markus Kordes, Frankenthal (DE); Wolfgang Von Deyn, Neustadt (DE); Michael Hofmann, Ludwigshafen (DE); Ernst Baumann, Dudenhofen (DE); Michael Puhl, Lampertheim (DE); Gain Heffernan, Florence, NJ (US); Deborah L Culbertson, Fuguay Varina, NC (US); Michael F Treacy, Corpus Christisty, MT (US)

Correspondence Address: HUTCHISON LAW GROUP PLLC, PO BOX 31686, RALEIGH, NC, 27612, US

(21) Appl. No.: 10/547,914

(22) PCT Filed: Feb. 20, 2004
(86) PCT No.: PCT/EP04/01677

§ 371 Date: Sep. 8, 2005

Related U.S. Application Data
(60) Provisional application No. 60/452,941, filed on Mar. 10, 2003.

(51) Int. Cl. A01N 43/84

(52) U.S. Cl. 514/232.5; 514/237.5

(57) ABSTRACT

Use of compounds Formula (I), A=a 5- to 7-membered ring which may contain 1-3 heteroatoms and which may be saturated or partially or completely unsaturated; R¹═OH, SH, NH₂, CN, NO₂, halogen, C₁-C₆-alkyl, C₁-C₆-haloalkyl; C₁-C₆-alkoxy, C₁-C₆-haloalkoxy, C₁-C₆-alkylthio, C₁-C₆-haloalkylthio, C₂-C₆-alkenyl, C₂-C₆alkenyloxy, C₂-C₆-alkenylthio, C₂-C₆-alkynyl, C₂-C₆-alkynyloxy, C₂-C₆-alkynylthio, C₁-C₆-alkylsulfonyl, C₁-C₆-alkylsulfoxyl, C₂-C₆-alkenylsulfonyl, C₂-C₆-alkylsulfoxyl, C₁-C₆-alkylcarbonyl, C₁-C₆-alkoxycarbonyl, C₁-C₆-aklylcarbonyloxy; R²═C₁-C₆-alkyl or a mono- or bicyclic 5- to 10-membered aromatic ringsystem which may contain 1 to 4 heteroatoms and which is either bonded directly or through an O, S, C₁-C₆-alkylene or C₁-C₆-alkyleneoxy linkage to A or fused to A and which may be substituted; R³, R⁴═H, C₁-C₆-alkyl, C₁-C₆-haloalkyl, C₁-C₆-alkyl-amino, C₁-C₆-alkoxy, C₃-C₆-cycloalkyl, or R³ and R⁴ together with the nitrogen atom to which they are attached form a saturated or partially saturated mono- or bicyclic 5- to 10-membered ring system containing 1 to 3 heteroatoms or a 5-membered hetaryl containing 1 to 4 nitrogen atoms, wherein the carbon and/or nitrogen atoms in the ring systems may be substituted or phenyl or benzyl which may be substituted; or R³ and R⁴ together form the chains —(CH₂)₂N⁺(O—)(CH₂)₂— or —(CH₂)₃N⁺(O⁻)(CH₂)₂—; m=0 to 4; n is 0 to 4; and the enantiomers, diastereomers, cis/trans isomers or salts thereof for combatting insects, arachnids or nematodes, methods for the control of these pests and of protecting growing plants attack or infestation by these pests by applying a pesticidally effective amount of a compound of formula (I), processes for preparing them, and compositions comprising them.

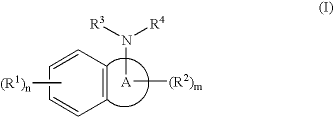

The present invention relates to the use of amino substituted benzo(hetero)cyclic derivatives of the formula I 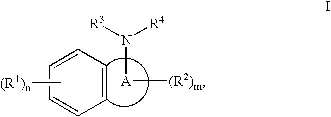
wherein
A is a 5- to 7-membered ring which, in addition to carbon atoms, may contain 1-3 heteroatoms, each selected from the group oxygen, sulfur and nitrogen, and which may be saturated or partially or completely unsaturated;
R¹ is hydroxy, mercapto, amino, cyano, nitro, halogen, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₂-C₆-alkenyl, C₂-C₆-alkenyloxy, C₂-C₆-alkenylthio, C₂-C₆-alkynyl, C₂-C₆-alkynyloxy, C₂-C₆-alkynylthio, C₁-C₆-alkylsulfonyl, C₁-C₆-alkylsulfoxyl, C₂-C₆-alkenylsulfonyl, C₂-C₆-alkynylsulfoxyl, (C₁-C₆-alkyl)carbonyl, (C₁-C₆-alkoxy)carbonyl or (C₁-C₆-alkyl)carbonyloxy;
R² is C₁-C₆-alkyl or a mono- or bicyclic 5- to 10-membered aromatic ringsystem which may contain 1 to 4 heteroatoms and which is either bonded directly or through an oxygen, sulfur, C₁-C₆-alkylene or C₁-C₆-alkyleneoxy linkage to A, and which is unsubstituted or substituted with any combination of 1 to 3 substituents, each selected from the group consisting of cyano, nitro, hydroxy, mercapto, amino, carboxyl, halogen, C₁-C₆-alkyl, C₁-C₆-haloalkyl, C₁-C₆-alkoxy, C₂-C₆-alkenyloxy, C₂-C₆-alkynyloxy, C₁-C₆-haloalkoxy, C₁-C₆-alkylthio or C₁-C₆-haloalkylthio;
R³, R⁴ are each independently hydrogen, C₁-C₆-alkyl, C₁-C₆-haloalkyl, C₁-C₆-alkylamino, C₁-C₆-alkoxy or C₃-C₆-cycloalkyl, or
R³ and R⁴ together with the nitrogen atom to which they are attached form a saturated or partially saturated mono- or bicyclic 5- to 10-membered ringsystem containing 1 to 3 heteroatoms selected from nitrogen and oxygen or 5-membered hetaryl containing 1 to 4 nitrogen atoms, wherein the carbon and/or nitrogen atoms in the saturated, partially saturated or aromatic rings are unsubstituted or substituted with any combination of 1 to 4 groups selected from amino, C₁-C₆-alkyl, C₂-C₆-alkenyl, C₂₋C₆-alkynyl, C₁-C₆-alkoxy, C₂-C₆-alkenyloxy, C₂-C₆-alkynyloxy, C₁-C₆-alkylthio, C₂-C₆-alkenylthio, C₂-C₆-alkynylthio, C₁-C₆-alkylamino, di(C₁-C₆-alkyl)amino, C₂-C₆-alkenylamino, C₂-C₆-alkynylamino, C₁-C₆-hydroxyalkyl, hydroxycarbonyl-C₁-C₄-alkyl, (C₂-C₆-alkoxy)carbonyl-C₁-C₄-alkyl, (C₁-C₆-alkyl)carbonyl-C₁-C₄-alkoxy, C₃-C₆-cycloalkyl, which is bonded directly or via C₁-C₆-alkyl linkage, and C₅-C₈-cycloalkenyl or
phenyl or benzyl which may be substituted by cyano, nitro, hydroxy, mercapto, amino, carboxyl, halogen, C₁-C₆-alkyl, C₁-C₆-haloalkyl, C₁-C₆-alkoxy, C₂-C₆-alkenyloxy, C₂-C₆-alkynyloxy, C₁-C₆-haloalkoxy, C₁-C₆-alkylthio or C₁-C₆-haloalkylthio; or
R³ and R⁴ together form the chains —(CH₂)₂N⁺(O^{-)(CH}₂)₂—or —(CH₂)₃N⁺(O⁻)(CH₂)₂—;
m is 0, 1, 2, 3 or 4;
n is 0, 1, 2, 3 or 4;

and the enantiomers, diastereomers, cis/trans isomers or salts thereof for combatting insects, arachnids or nematodes.

In spite of the commercial insecticides, acaricides and nematicides available today, damage to crops, both growing and harvested, caused by insects, arachnids and nematodes still occurs. Therefore, there is continuing need to develop new insecticidal, acaricidal and nematicidal agents.

It was therefore an object of the present invention to provide new pesticidal compositions, new compounds and new methods for the control of insects, arachnids or nematodes and of protecting growing plants from attack or infestation by insects, arachnids or nematodes.

We have found that these objects are achieved by the compounds of formula I. Furthermore, we have found processes for preparing the compounds of formula I and compositions comprising them.

Some compounds of formula I have been described inter alia in J. Med. Chem. 26, 935 (1983), J. Med. Chem. 38, 4380 (1995), Eur. J. Med. Chem. 23, 173 (1988), DE-A 2 135 458, EP-A 745 597 and U.S. Pat. No. 5,780,470. However, an insecticidal, acaricidal or nematicidal activity of compounds of formula I has not been known yet.

Depending on the substitution pattern, the compounds of formula I can contain one or more chiral centers, in which case they are present as enantiomer or diastereomer mixtures. Furthermore, the compounds of formula I can be geometric cis/trans isomers. Subject-matter of this invention are not only compositions containing these mixtures but also those containing the pure enantiomers or diastereomers.

The preparation of the compounds of formula I may lead to them being obtained as isomer mixtures. If desired, these can be resolved by the methods customary for this purpose, such as crystallization or chromatography, also on optically active adsorbate, to give the pure isomers.

Agronomically acceptable salts of the compounds I are those which do not adversely affect the pesticidal action in comparison with the free compounds I.

The organic moieties mentioned for the substituents R¹ to R⁴ or as radicals on phenyl rings or heterocycles are—like the meaning halogen—collective terms for individual enumerations of the individual group members. All carbon chains, i.e. all alkyl, haloalkyl, alkoxy, haloalkoxy, alkylthio, haloalkylthio, alkenyl and alkynyl moieties can be straight-chain or branched. Unless otherwise indicated, halogenated substituents have attached to them one to five identical or different halogen atoms.

Examples of individual meanings are:

“Halogen” means fluoro, chloro, bromo and iodo.

The term “alkyl” as used herein refers to a branched or unbranched saturated hydrocarbon group having 1 to 8 carbon atoms, for example C₁-C₆-alkyl such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl.

The term “haloalkyl” as used herein refers to a straight-chain or branched alkyl groups having 1 to 6 carbon atoms (as mentioned above), where some or all of the hydrogen atoms in these groups may be replaced by halogen atoms as mentioned above, for example C₁-C₂-haloalkyl, such as chloromethyl, bromometnyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl and pentafluoroethyl;

“Alkylamino” refers to a straight-chain or branched alkyl group having 1 to 6 carbon atoms (as mentioned above) which is bonded through a nitrogen linkage.

Similarly, “alkoxy” and “alkylthio” refer to straight-chain or branched alkyl groups having 1 to 6 or 1 to 8 carbon atoms (as mentioned above) bonded through oxygen or sulfur linkages, respectively, at any bond in the alkyl group. Examples include methoxy, ethoxy, propoxy, isopropoxy, methylthio, ethylthio, propylthio, isopropylthio, and n-butylthio.

The term “alkenyl” as used herein intends a branched or unbranched unsaturated hydrocarbon group having 2 to 6 carbon atoms and a double bond in any position, such as ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl; 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, I-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl;

The term “alkynyl” as used herein refers to a branched or unbranched unsaturated hydrocarbon group containing at least one triple bond, such as ethynyl, propynyl, 1-butynyl, 2-butynyl, and the like.

Aryl: mono- or bicyclic 5- to 10-membered aromatic ringsystem, e.g. phenyl or naphthyl;

Hetaryl: a 5- to 10-membered heteroaromatic ring system containing 1 to 4 heteroatoms selected from oxygen, sulfur and nitrogen, e.g. 5-membered hetaryl, containing 1 to 4 nitrogen atoms, such as pyrrolyl, pyrazolyl, imidazolyl, triazolyl, and tetrazolyl; or 5-membered hetaryl, containing 1 to 4 nitrogen atoms or 1 to 3 nitrogen atoms and 1 sulfur or oxygen atom, e.g. furyl, thienyl, pyrrolyl, isoxazolyl, isothiazolyl, pyrazolyl, oxazolyl, thiazolyl, imidazolyl, oxadiazolyl, thiadiazolyl, oxadiazolyl, triazolyl, and tetrazolyl; or

5-membered hetaryl, containing 1 to 4 nitrogen atoms or 1 to 3 nitrogen atoms and 1 sulfur or oxygen atom, in which two adjacent ring carbon atoms or one nitrogen atom and an adjacent carbon atom can be bridged by buta-1,3-dien-1,4-diyl; or 6-membered hetaryl, containing 1 to 4 nitrogen atoms or 1 to 3 nitrogen atoms and 1 sulfur or oxygen atom, e.g. 2-pyridinyl, 3-pyridinyl, 4-pyridinyl, 3-pyridazinyl, 4-pyridazinyl, 2-pyrimidinyl, 4-pyrimidinyl, 5-pyrimidinyl, 2-pyrazinyl, 1,3,5-triazin-2-yl and 1,2,4-triazin-3-yl;

A saturated or partially saturated mono- or bicyclic 5- to 10-membered ringsystem containing 1 to 3 heteroatoms selected from nitrogen and oxygen intends e.g. a saturated monocyclic 5- to 7-membered ringsystem containing 1 to 3 heteroatoms selected from nitrogen and oxygen, such as pyridine, pyrimidine, pyrrolidine, piperazine, homopiperazine, morpholine, and piperidine; or

e.g. a saturated bicyclic 7- to 10-membered ringsystem containing 1 to 3 heteroatoms selected from nitrogen and oxygen, such as 1,4-diazabicyclo[4.3.0]nonane, 2,5-diazabicyclo[2.2.2]octane, and 2,5-diazabicyclo[2.2.1]heptane.

C₃-C₆-Cycloalkyl means cyclopropyl, cyclobutyl, cyclopentyl, cyclohexyl, cycloheptyl and cyclooctyl.

“Salt” as used herein includes adducts of compounds I with maleic acid, dimaleic acid, fumaric acid, difumaric acid, methane sulfenic acid, methane sulfonic acid, and succinic acid. Additional salt formers include chloride, sulfate, acetate, carbonate, hydride, and hydroxide. Desirable salts include adducts of compounds I with maleic acid, dimaleic acid, fumaric acid, difumaric add, and methane sulfonic acid.

With a view to the novel use of the compounds I as pesticides the variables preferably have the following meanings, in each case on their own or in combination:
A a 5- to 7-membered ring which, in addition to carbon atoms, may contain 1 oxygen or sulfur atom, and which may be saturated or partially unsaturated, or completely unsaturated like phenyl and heteroaryl;

in particular a 5- to 7-membered saturated ring which, in addition to carbon atoms, may contain 1 oxygen or sulfur atom;
R¹ halogen, C₁-C₆-alkyl, C₁-C₆-haloalkyl, C₁-C₆-alkoxy, C₁-C₆-alkylthio or C₁-C₆-haloalkylthio, in particular fluorine, chlorine, methyl, trifluoromethyl, methoxy, methylthio or trifluoromethylthio;
R² phenyl, which is substituted by halogen, C₁-C₆-alkyl, C₁-C₆-haloalkyl, C₁-C₆-alkylthio or C₁-C₆-haloalkylthio,
in particular phenyl, substituted by fluorine, chlorine, C₁-C₄-alkyl, trifluoromethyl, C₁-C₄-alkylthio or trifluoromethylthio;
m 0, 1, 2, 3 or 4, in particular 1;
n 0, 1, 2, 3 or 4, in particular 0 or 1.

The compounds useful in the present invention may be readily synthesized using techniques generally known by synthetic organic chemists. Exemplary synthesis methods are described in the above mentioned documents.

Those compounds of formula I in which the ring A is a saturated ring (compounds Ia) can be advantageously prepared starting from the corresponding bicyclic ketones II by a single step hydroamination process as described in the literature. In this reaction the bicyclic ketone is reacted with the corresponding amine in the presence of a reducing agent like sodiumcyanoborohydride in an inert solvent, advantageously in an alcohol, at temperatures from 20° to 130° C.:

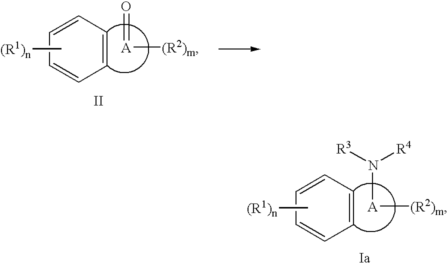

Those compounds of formula I in which the ring A contains a double bond at the position of the amine substituent (compounds Ib) may be prepared in a single step by reaction of the corresponding ketone II with the corresponding amine in the presence of a Lewis acid, advantageously TiCl4, in an inert solvent, advantageously toluene or xylene, at temperatures from 20° to 150° C.:

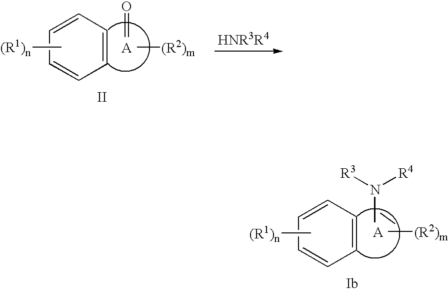

Those compounds of formula I in which the ring A is an aromatic or heteroaromatic ring (compounds Ic) can be advantageously prepared starting from the corresponding bicyclic bromide or chloride III by reaction with the corresponding amine in the presence of a catalytic amount of a suitable arylphosphine, for example triphenyl- or tris-o-tolylphosphine, and a Pd catalyst like Pd-acetate or tetrakisphenylpalladium, or with a known Buchwald Pd catalyst (see J. Am. Chem. Soc. 121, 4369 (1999)) in an inert solvent like toluene at temperatures from 20° to 150° C.:

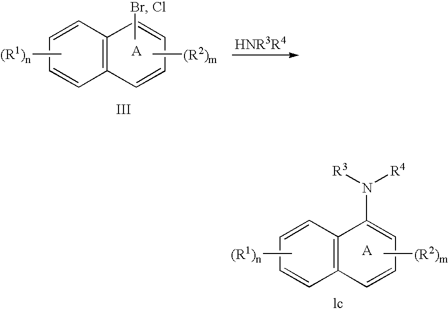

Those compounds of formula I in which the ring A forms an amidine structure with NR³R⁴ (compounds Id) can be advantageously prepared in a manner known per se starting from the corresponding bicyclic amide IV by reaction with the corresponding amine in the presence of a Lewis acid like TiCl₄ in an inert solvent like toluene or xylene at temperatures from 20° to 130° C.:

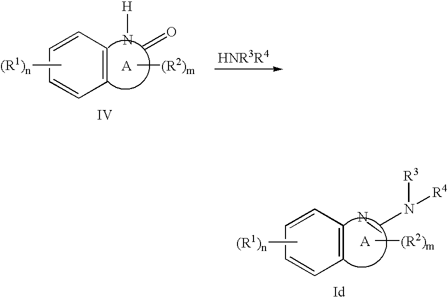

The bicycaic ketones of the formula II are known in the literature (J. Org. Chem. 50(24), 4933 (1985); J. Am. Chem. Soc. 75, 1891 (1953); J. Chem Soc., 4797 (1961); Arch. Pharmaz. 308, 94 (1975); J. Org. Chem. 55, 3537 (1990); J. Med. Chem. 14, 90 (1971); J. Am. Chem. Soc. 76, 1641 (1954); J. Org. Chem. 23, 344 (1958); Synthetic Comm. 21, 981 (1991); J. Org. Chem. 55, 4822 (1990); J. Med. Chem. 28, 1817 (1985) or can be prepared according to the known procedures.

The bicyclic aromatic bromides or chlorides are commercially available or wellknown compounds described in the literature.

The compounds of the formula I can have one or more chiral centers, in which case they are usually obtained as enantiomer or diastereomer mixtures. If desired, the mixtures can be separated into the essentially pure isomers by customary methods, for example by means of crystallization or chromatography on an optically active adsorbate. Pure optically active isomers can, for example, also be prepared from the corresponding optically active starting materials.

Those compounds I which contain a basic nitrogen can be converted into their acid addition salts, in a manner known per se.

The reaction mixtures are worked up in a customary manner, for example by mixing with water, phase separation and, if appropriate, chromatographic purification of the crude products. In some cases, the intermediates and end products are obtained in the form of colorless or pale brown viscous oils, which are purified or freed from volatile components under reduced pressure and at moderately elevated temperature. If the intermediates and end products are obtained as solids, they can also be purified by recrystallization or digestion.

If individual compounds I are not obtainable by the route described above, they can be prepared by derivatization of other compounds I or by customary modifications of the synthesis routes described.

The preparation of the compounds of formula I may lead to them being obtained as isomer mixtures. If desired, these can be resolved by the methods customary for this purpose, such as crystallization or chromatography, also on optically active adsorbate, to give the pure isomers.

Agronomically acceptable salts of the compounds I can be formed in a customary manner, e.g. by reaction with an acid of the anion in question.

The amino substituted benzo(hetero)cyclic derivatives I and the pure enantiomers, diastereomers, cis/trans isomers and salts thereof are suitable as pesticides, preferable for an efficient control of insects, arachnids and nematodes in crop protection.

In particular, the compounds I are suitable for controlling the following animal pests:

Insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus pinianius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nftidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keifera lycopersicelia, Lambdina fiscellana, Laphygma exigua, Leucoptera coffeella, Leucoptere scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalls, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera mlura, Thaumatopoea pityocampa, Tortrix viridana, Trichoplusia ni and Zeiraphera canadensis,

beetles (Coleoptera), for example Agrilus sinuatus, Agniotes lineatus, Agriotes obscurus, Amphimallus soistitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicomis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popilliajaponica, Sitona lineatus and Sitophilus granaria,

dipterans (Diptera), for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbiftae, Dacus oleae, Dasineura brassicae, Fannia canicularis, Gasterophilus intestinalis, Glossina morsitans, Haematobia irritans, Haplodiplosis equeslris, Hylemyia platura, Hypoderrna lineata, Liriomyza sativae, Liriomyza trifolli, Lucilia caprina, Lucilia cuprina, Lucilia sericata, Lycoria pectoralis, Mayetiola destructor, Musca domestica, Muscina stabulans, Oestrus ovis, Oscinella fit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa,

thrips (Thysanoptera), e.g. Frankliniella fusca, Frankliniella occidentalis, Frankliniella tritici, Scirtothrips citri, Thrips oryzae, Thrips palmi and Thrips tabaci,

hymenopterans (Hymenoptera), e.g. Athalia rosae, Atta cephalotes, Atta sexdens, Atta texana, Hoplocampa minuta, Hoplocampa testudinea, Monomorium pharaonis, Solenopsis geminata and Solenopsis invicta,

heteropterans (Heteroptera), e.g. Acrostemum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara vindula, Piesma quadrata, Solubea insularis and Thyanta perditor,

homopterans (Homoptera), e.g. Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus homi, Cerosipha gossypii, Chaetosiphon fraagaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyranus, Metopolophium dirhodum, Myzodes persicae, Myzus ascalonicus, Myzus cerasi, Myzus vanans, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sftobion avenae, Trialeurodes vaporanorum, Toxoptera aurantliand, and Viteus vitifolii.

termites (Isoptera), e.g. Calotermes flavicollis, Leucoternes flavipes, Reticulitermes lucifugus und Termes natalensis,

orthopterans (Orthoptera), e.g. Acheta domestica, Blatta orientalis, Blattella germanica, Forficula auriculana, Gryllotalpa gryllotalpa, Locusta migratoda, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus,

Arachnoidea, such as arachnids (Acarina), e.g. of the families Argasidae, lxodidae and Sarcoptidae, such as Amblyomma americanum, Amblyomma variegatum, Argas persicus, Boophilus annulatus, Boophilus decoloratus, Boophilus microplus, Dennacentor silvarum, Hyalomma truncatum, Ixodes ricinus, Ixodes rubicundus, Omithodorus moubata, Otobius megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus paciricus, Tetranychus telarius and Tetranychus urticae, Panonychus ulmi, Panonychus citni, and oligonychus pratensis;

Nematodes, including plant parasitic nematodes and nematodes living in the soil. Plant parasitic nematodes include, such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species; Sting nematodes, Belonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Hellcotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Pin nematodes, Paratylenchus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species.

The compounds I and compositions containing them are especially useful for the control of insects and nematodes, in particular for the control of insects.

Moreover, the compounds I and compositions containing them are especially useful for the control of pests selected from the orders Homoptera, Lepidoptera, Diptera, Thysanoptera, and Nematoda.

The compounds of formula (I) may be used to protect growing plants from attack or infestation by insects, arachnids or nematodes by contacting the plant with a pesticidally effective amount of compounds of formula (I).

The insect, arachnid, nematode, plant and/or soil or water in which the plant is growing can be contacted with the present compound(s) or composition(s) by any application method known in the art. As such, “contacting” includes both direct contact (applying the compounds/compositions directly on the insect, arachnid, nematode, and/or plant—typically to the foliage, stem or roots of the plant) and indirect contact (applying the compounds/compositions to the locus of the insect, arachnid, nematode, and/or plant).

Moreover, insects, arachnids or nematodes may be controlled by contacting the target parasite/pest, its food supply or its locus with a pesticidally effective amount of compounds of formula (I). As such, the application may be carried out before or after the infection of the locus, growing crops, or harvested crops by the pest.

“Locus” means a habitat, breeding ground, plant, seed, soil, area, material or environment in which a pest or parasite is growing or may grow.

In general, for use in treating crop plants, the rate of application of the compounds and/or compositions of this invention may be in the range of about 0.1 g to about 4000 g per hectare, desirably from about 25 g to about 600 g per hectare, more desirably from about 50 9 to about 500 g per hectare. For use in treating seeds, the typical rate of application is of from about 1 g to about 500 g per kilogram of seeds, desirably from about 2 g to about 300 g per kilogram of seeds, more desirably from about 10 g to about 200 g per kilogram of seeds. Customary application rates in the protection of materials are, for example, from about 0.001 g to about 2 kg, desirably from about 0.005 g to about 1 kg, of active compound per cubic meter of treated material.

The compounds I can be converted into the customary formulations, e.g. solutions, emulsions, microemulsions, suspensions, flowable concentrates, dusts, powders, pastes and granules. The use form depends on the particular purpose; in any case, it should guarantee a fine and uniform distribution of the compound according to the invention.

The formulations are prepared in a known manner, e.g. by extending the active ingredient with solvents and/or carriers, if desired using emulsifiers and dispersants, it also being possible to use other organic solvents as auxiliary solvents if water is used as the diluent. Auxiliaries which are suitable are essentially: solvents such as aromatics (e.g. xylene), chlorinated aromatics (e.g. chlorobenzenes), paraffins (e.g. mineral oil fractions), alcohols (e.g. methanol, butanol), ketones (e.g. cyclohexanone), amines (e.g. ethanolamine, dimethylformamide) and water; carriers such as ground natural minerals (e.g. kaolins, clays, talc, chalk) and ground synthetic minerals (e.g. highly-disperse silica, silicates); emulsifiers such as non-ionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates and fatty acids and their alkali metal and alkaline earth metal salts, salts of sulfated fatty alcohol glycol ether, condensates of sulfonated naphthalene and naphthalene derivatives with formaldehyde, condensates of naphthalene or of napthalenesulfonic acid with phenol or formaldehyde, polyoxyethylene octylphenyl ether, ethoxylated isooctylphenol, octylphenol, nonylphenol, alkylphenol polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, e.g. benzene, toluene, xylene, paraffin, tetrahydronaphthalene, alkylated naphthalenes or their derivatives, methanol, ethanol, propanol, butanol, chloroform, carbon tetrachloride, cyclohexanol, cyclohexanone, chlorobenzene, isophorone, strongly polar solvents, e.g. dimethylformamide, dimethyl sulfoxide, N-methylpyrrolidone and water.

Powders, materials for scattering and dusts can be prepared by mixing or concomitantly grinding the active substances with a solid carrier.

Granules, e.g. coated granules, compacted granules, impregnated granules and homogeneous granules, can be prepared by binding the active ingredients to solid carriers. Examples of solid carriers are mineral earths, such as silicas, silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, e.g. ammonium sulfate, ammonium phosphate, ammonium nitrate, ureas, and products of vegetable origin, such as cereal meal, tree bark meal, wood meal and nutshell meal, cellulose powders and other solid carriers.

Such formulations or compositions of the present invention include a formula I compound of this invention (or combinations thereof admixed with one or more agronomically acceptable inert, solid or liquid carriers. Those compositions contain a pesticidally effective amount of said compound or compounds, which amount may vary depending upon the particular compound, target pest, and method of use.

In general, the formulations comprise of from 0.01 to 95% by weight, preferably from 0.1 to 90% by weight, of the active ingredient. The active ingredients are employed in a purity of from 90% to 100%, preferably 95% to 100% (according to NMR spectrum).

The following are exemplary formulations:
I. 5 parts by weight of a compound according to the invention are mixed intimately with 95 parts by weight of finely divided kaolin. This gives a dust which comprises 5% by weight of the active ingredient.
II. 30 parts by weight of a compound according to the invention are mixed intimately with a mixture of 92 parts by weight of pulverulent silica gel and 8 parts by weight of paraffin oil which had been sprayed onto the surface of this silica gel. This gives a formulation of the active ingredient with good adhesion properties (comprises 23% by weight of active ingredient).
III. 10 parts by weight of a compound according to the invention are dissolved in a mixture composed of 90 parts by weight of xylene, 6 parts by weight of the adduct of 8 to 10 mol of ethylene oxide and 1 mol of oleic acid N-monoethanolamide, 2 parts by weight of calcium dodecylbenzenesulfonate and 2 parts by weight of the adduct of 40 mol of ethylene oxide and 1 mol of castor oil (comprises 9% by weight of active ingredient).
IV. 20 parts by weight of a compound according to the invention are dissolved in a mixture composed of 60 parts by weight of cyclohexanone, 30 parts by weight of isobutanol, 5 parts by weight of the adduct of 7 mol of ethylene oxide and 1 mol of isooctylphenol and 5 parts by weight of the adduct of 40 mol of ethylene oxide and 1 mol of castor oil (comprises 16% by weight of active ingredient).
V. 80 parts by weight of a compound according to the invention are mixed thoroughly with 3 parts by weight of sodium diisobutylnaphthalene-alpha-sulfonate, 10 parts by weight of the sodium salt of a lignosulfonic acid from a sulfite waste liquor and 7 parts by weight of pulverulent silica gel, and the mixture is ground in a hammer mill (comprises 80% by weight of active ingredient).
VI. 90 parts by weight of a compound according to the invention are mixed with 10 parts by weight of N-methyl-a-pyrrolidone, which gives a solution which is suitable for use in the form of microdrops (comprises 90% by weight of active ingredient).
VII. 20 parts by weight of a compound according to the invention are dissolved in a mixture composed of 40 parts by weight of cyclohexanone, 30 parts by weight of isobutanol, 20 parts by weight of the adduct of 7 mol of ethylene oxide and 1 mol of isooctylphenol and 10 parts by weight of the adduct of 40 mol of ethylene oxide and 1 mol of castor oil. Pouring the solution into 100000 parts by weight of water and finely distributing it therein gives an aqueous dispersion which comprises 0.02% by weight of the active ingredient.

VIII. 20 parts by weight of a compound according to the invention are mixed thoroughly with 3 parts by weight of sodium diisobutyinaphthalene-a-sulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20000 parts by weight of water gives a spray mixture which comprises 0.1% by weight of the active ingredient.

The active ingredients can be used as such, in the form of their formulations or the use forms prepared therefrom, e.g. in the form of directly sprayable solutions, powders, suspensions or dispersions, emulsions, oil dispersions, pastes, dusts, materials for spreading, or granules, by means of spraying, atomizing, dusting, scattering or pouring.

The use forms depend entirely on the intended purposes; in any case, this is intended to guarantee the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances as such or dissolved in an oil or solvent, can be homogenized in water by means of wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use products can be varied within substantial ranges. In general, they are from 0.0001 to 10%, preferably from 0.01 to 1%.

The active ingredients may also be used successfully in the ultra-low-volume process (ULV), it being possible to apply formulations comprising over 95% by weight of active ingredient, or even the active ingredient without additives.

Compositions of this invention may also contain other active ingredients, for example other pesticides, insecticides, herbicides,-fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients.

These agents can be admixed with the agents according to the invention in a weight ratio of 1:10 to 10:1. Mixing the compounds I or the compositions comprising them in the use form as pesticides with other pesticides frequently results in a broader pestcidal spectrum of action.

The following list of pesticides together with which the compounds according to the invention can be used, is intended to illustrate the possible combinations, but not to impose any limitation:

Organophosphates: Acephate, Azinphos-methyl, Chlorpyrifos, Chlorfenvinphos, Diazinon, Dlchlorvos, Dicrotophos, Dimetuhoate, Disuifoton, Ethion, Fenitrothion, Fenthion, Isoxathion, Malathion, Methamidophos, Methidathion, Methyl-Parathion, Mevinphos, Monocrotophos, Oxydemeton-methyl, Paraoxon, Parathion, Phenthoate, Phosalone, Phosmet, Phosphamidon, Phorate, Phoxim, Pirimiphos-methyl, Profenofos, Prothiofos, Suiprophos, Triazophos, Trichlorfon;

Carbamates: Alanycarb, Benfuracarb, Carbaryl, Carbosulfan, Fenoxycarb, Furathiocarb, lndoxacarb, Methiocarb, Methomyl, Oxamyl, Pirimicarb, Propoxur, Thiodicarb, Triazamate;

Pyrethroids: Bifenthrin, Cyfluthrin, Cypermethrin, Deltamethrin, Esfenvalerate, Ethofenprox, Fenpropathrin, Fenvalerate, Cyhalothrin, Lambda-Cyhalothrin, Permethrin, Silafluofen, Tau-Fluvalinate, Tefluthrin, Tralomethrin, Zeta-Cypermethrin;

Arthropod growth regulators: a) chitin synthesis inhibitors: benzoylureas: Chlorfluazuron, Diflubenzuron, Flucycloxuron, Flufenoxuron, Hexaflumuron, Lufenuron, Novaluron, Teflubenzuron, Triflumuron; Buprofezin, Diofenolan, Hexythiazox, Etoxazole, Clofentazine; b) ecdysone antagonists: Halofenozide, Methoxyfenozide, Tebufenozide; c) juvenoids: Pyriproxyfen, Methoprene, Fenoxycarb; d) lipid biosynthesis inhibitors: Spirodiclofen;

Various: Abamectin, Acequinocyl, Amitraz, Azadirachtin, Bifenazate, Cartap, Chlorfenapyr, Chlordimeform, Cyromazine, Diafenthiuron, Dinetofuran, Diofenolan, Emamectin, Endosulfan, Ethiprole, Fenazaquin, Fipronil, Formetanate, Formetanate hydrochloride, Hydramethylnon, Imidacloprid, Indoxacarb, Pyridaben, Pymetrozine, Spinosad, Sulfur, Tebufenpyrad, Thiamethoxam, and Thiocyclam.

### PREPARATION EXAMPLES

### Example 1

### Preparation of 1-(5-methoxy-1,2,3,4-tetrahydro-1-naphthalenyl)-4-methylpiperazine

A mixture of 2.1 g 5-methoxy-1-tetraline, 3.7 ml 1-methylpiperazine, 2.15 g sodium-cyanoborohyhdride and 0.7 ml acetic acid in 40 ml methanol was refluxed for 30 hours under nitrogen. After cooling to 25° C., the reaction mixture was poored into ice/water and extracted with ethylacetate at pH=9. The organic phase was washed with water, dried and concentrated under reduced pressure to yield 2.5 g oil. The crude product was purified by column chromatography (silica gel; eluent: CH₂Cl₂/CH₃OH=92:7). Yield: 1.8 g; m.p.: 69-71° C.

### Example 2

### 40 Preparation of 1-methyl-4-(6,7,8,9-tetrahydro-5H-benzo[a]cyclohepten-5-yl)-piperazine

A mixture of 3.0 g 5-benzosuberone, 4.2 ml 1-methylpiperazine, 2.85 g sodiumcyanoborohyhdride and 1.0 ml acetic acid in 50 ml methanol was refluxed for 9 hours under nitrogen. After cooling to 25° C. the reaction mixture was poored into ice/water and extracted with ethyl-acetate at pH=9. The organic phase was washed with water, dried and concentrated under reduced pressure to yield 3.7 g oil. The crude product was purified by column chromatography (silica gel; eluent: CH₂Cl₂/CH₃OH=95:5) to yield 2.29 product as an oil.

¹H-NMR (CDCl₃): δ [ppm]=7.1 (m), 3.5 (t), 3.1 (d), 2.5 (m), 2.3 (s), 2.2 (m), 2.1 (m), 1.6 (m), 1.4 (m).

### Example 3

### 1-Methyl-4-(2H-thiochromen-4-yl)-piperazine

4.33 g TICl₄ was added to 70 ml toluene. Then 12.2 g of 1-methylpiperazine were added under stirring and cooling with an ice bath. Subsequently 2.5 of thiochroman-4-on were added under stirring. The resulting reaction mixture was stirred for 4 hours at 25° C. Thereafter the reaction mixture was poored into ice/water and ethylacetate. The precipitate was filtered off. After separation of the organic phase, the water phase was extracted a second time with ethylacetate. The combined organic phases were washed with water, dried and concentrated under reduced pressure to yield 3.55 g product. MS: m/z [M+H]⁺=247.

### Example 4

### Preparation of 1-[3-(4-chlorophenyl)-2,3-dihydro-1H-inden-1-yl]-4-methylpiperazine

a) 3-(4-Chlorophenyl)-2,3-dihydro-1H-inden-1-one

11.8 g 3-(4-Chiorophenyl)-3-phenyl-propanoic acid in 150 g polyphosphonc acid were heated at 110° C. for 2.5 hours. After cooling to 25° C., ice water was added. The reaction mixture was extracted with CH₂Cl₂. The organic phase was washed with water, dried and concentrated under reduced pressure to yield 11.0 g of a viscous oil. The crude product was purified by column chromatography (silica gel; eluent: heptane/ethylacetate=75:25). Yield: 4.8 g.

b) 1-[3-(4-Chlorophenyl)-2,3-dihydro-1H-inden-1-yl]4-methylpiperazine

A mixture of 3.0 g 3-(4-chlorophenyl)-2,3-dihydro-1H-inden-1-one, 2.0 ml 1-methylpiperazine, 1.0 g sodiumcyanoborohyhdride and 0.8 ml acetic acid in 50 ml n-propanol was refluxed for 8 hours under nitrogen. After cooling to 25° C., the reaction mixture was poored into ice/water. Then, the product was extracted with ethylacetate at pH=9. The organic phase was washed with water, dried and concentrated under reduced pressure to yield 3.0 g oil as the cis, trans isomer mixture.

The separation of the cis, trans isomers was achieved by column chromatography (silica gel; eluent: CH₂Cl₂/CH₃OH=95:5).

Yield of cis isomer: 0.72 g; ¹H-NMR (CDCl₃): δ [ppm]=7.4 (d), 7.2 (m), 7.0 (d), 6.9 (d), 4.4 (m), 2.7 (m), 2.6 (m), 2,5 (m), 2.3 (s), 2.0 (m);

yield of trans isomer: 0.63 g; ¹H-NMR (CDCl₃): δ [ppm]=7.4 (d), 7.3 (m), 7.2 (m), 7.1 10 (d), 6.9 (d), 4.4 (m), 4.1 (m), 2.7 (m), 2.5 (m), 2.3 (s), 2.0 (m).

### Example 5

### 1-Methyl-4-(1-naphthyl)-piperazine

A mixture of 50 g 1-bromonaphthalene, 83 g piperazine, 5.42 g Pd(OCO-CH₃)₂, 14.7 g tris-o-tolylphosphine and 37.8 g potassium tert.-butanolate in 400 ml xylene was refluxed for 16 hours under nitrogen. After cooling to 25° C. the reaction mixture was diluted with 100 ml CH₂Cl₂, filtered and concentrated under reduced pressure. The residue was extracted between water and methyl-tert.-butyl-ether. The organic phase was dried and concentrated under reduced pressure to yield 48 g of crude product. The residue was purified by column chromatography (silica gel; eluent: tetrahydrofuran/CH₃OH/NH₃=85:15:2). Yield: 24 g of the desired product. ¹H-NMR (CDCl₃): δ [ppm]=8.2 (d), 7.8 (d), 7.6 (d), 7.5 (m), 7.4 (m), 7.1 (d), 3.1 (m), 2.7 (m), 2.4 (s).

### Example 6

### 4-(4-Methyl-1-piperazinyl)-2,3-dihydro-1,5-benzothiazepine

To a solution of 1.7 ml TiCl₄ in 80 ml toluene was added 10.7 ml 1-methylpiperazine slowly under cooling by an ice bath. Afterwards 1.9 g 2,3-dihydro-1,5-benzothiazepin-4(5H)-one was added and the reaction mixture was refluxed for 1 hour under nitrogen. After cooling to 25° C. the reaction mixture was poored into ice/water and extracted with ethylacetate at pH=9. The organic phase was washed with diluted ammonia, dried and concentrated in vacuo to yield 2.6 g oil. The crude product was purified by column chromatography (silica gel; eluent: CH₂Cl₂/CH₃OH=95/5). Yield: 2.2 g product as oil. ¹H-NMR (CDCl₃): δ [ppm]=7.5 (d), 7.3 (t), 7.0 (d), 6.9 (t),3.7 (m), 3.5 (t), 2.6 (t), 2.5 (t), 2.4 (s).

In addition to those mentioned above, other compounds I which were prepared, or can be prepared, in a similar manner are
7. 1-(1,2,3,4-Tetrahydro-1-naphthalenyl)-4-methylpiperazine; ¹H-NMR (CDCl₃): δ [ppm]=7.8 (d), 7.2 (m), 7.1 (m), 3.8 (m), 2.8 (m), 2.5 (m), 2.3 (s), 2.0 (m), 1.8 (m).
8. 1-(2,3-Dihydro-1H-inden-1-yl)-4-methylpiperazine; ¹H-NMR (CDCl₃): δ [ppm]=7.4 (d), 7.2 (m), 4.4 (t), 2.9 (m), 2.8 (m), 2.6 (m), 2.5 (m), 2.3 (s), 2.1 (m).
9. 1-(3,4-Dihydro-1-naphthalenyl)-4-ethylpiperazine; mp.=68-70° C.
10. 1-(1H-Inden-2-yl)-4-methylpiperazine; mp.=158-160° C.
11. 1-(1,2,3,4-Tetrahydro-1-naphthalenyl)-4-ethylpiperazine; ¹H-NMR (CDCl₃): δ [ppm]=7.8 (d), 7.1 (m), 7.0 (d), 3.9 (m), 2.8 (m), 2.6 (m), 2.5 (q), 2.0 (m), 1.8 (m), 1.0 (t).
12. 1-(1-Isoquinolinyl)-4-methylpiperazine; ¹H-NMR (CDCl₃): δ [ppm]=8.2 (d), 8.1 (d), 7.8 (d), 7.6 (m), 7.5 (m), 7.2 (d), 3.5 (m), 2.8 (m), 2.4 (s).
13. 1-(2,3-Dihydro-1H-inden-2-yl)-4-methylpiperazine; mp.=73-75° C.
14. 1-(1,2,3,4-Tetrahydro-2-naphthalenyl)-4-methylpiperazine; ¹H-NMR (CDCl₃): δ [ppm]=7.1 (m), 2.9 (m), 2.8 (m), 2.7 (m), 2.5 (m), 2.3 (s), 2.2 (m), 1.6 (m).
15. 1-(6-Chloro-2H-thiochromen-4-yl)-4-methylpiperazine; MS: m/z [M+H]⁺=281.
16. 1-(6-Chloro-3,4-dihydro-2H-thiochromen-4-yl)-4-methylpiperazine; ¹H-NMR (CDCl₃): δ [ppm]=7.6 (s), 7.1 (m), 7.0 (d), 3.7 (m), 3.1 (m), 3.0 (m), 2.7 (m), 2.5 (m), 2.3 (s), 2.1 (m).
17. 1-(3,4-Dihydro-2H-thiochromen-4-yl)-4-methylpiperazine; ¹H-NMR (CDCl₃): δ [ppm]=7.4 (d), 7.1 (d), 7.0 (m), 3.6 (m), 3.3 (m), 3.0 (m), 2.8 (m), 2.5 (m), 2.3 (s), 2.2 (m), 2.1 (m).
18. 1-(2,3-Dihydro-1-benzothiepin-5-yl)-4methylpiperazine; MS: m/z [M+H]⁺=261.
19. 1-(5-Chloro-1,2,3,4-tetrahydro-1-naphthalenyl)-4-methylpiperazine; mp.=75-78° C.
20. 1-(7-Fluoro-1,2,3,4-tetrahydro-1-naphthalenyl)-4-methylpiperazine; ¹H-NMR (CDCl₃): δ [ppm]=7.4 (d), 7.0 (m), 6.8 (m), 3.8 (m), 2.8 (m), 2.7 (m), 2.5 (m), 2.4 (s), 2.0 (m), 1.7 (m).
21. 1-(7-Fluoro-3,4-dihydro-1-naphthalenyl)-4-methylpiperazine; ¹H-NMR (CDCl₃): δ [ppm]=7.3 (m), 7.0 (m), 7.0 (m), 5.4 (m), 2.8 (m), 2.6 (m), 2.5 (m), 2.3 (s), 2.2 (m).
22. 1-(1H-Inden-2-yl)-4-ethylpiperazine; mp.=124-126° C.
23. 1-(6-Fluoro-1,2,3,4-tetrahydro-1-naphthalenyl)-4-methylpiperazine; ¹H-NMR (CDCl₃): δ [ppm]=7.6 (m), 6.8 (m), 6.7 (d), 3.8 (m), 2.6 (m), 2.3 (s), 2.0 (m), 1.7 (m).
24. 1-(5-Chloro-1-naphthyl)-4-methylpiperazine; ¹H-NMR (CDCl₃): δ [ppm]=8.2 (d), 8.0 (m), 7.5 (m), 7.4 (m), 7.2 (m), 3.1 (m), 2.7 (m), 2.5 (s).
25. 1-(7-Methoxy-1,2,3,4-tetrahydro-1-naphthalenyl)-4-methylpiperazine; ¹H-NMR (CDCl₃): δ [ppm]=7.3 (s),7.0 (d), 6.8 (d), 3.9 (s), 2.8 (m), 2.5 (m), 2.4 (s), 2.0 (m), 1.7 (m).
26. 1-(6,7-Dimethoxy-1,2,3,4-tetrahydro-1-naphthalenyl)-4-methylpiperazine; mp.=65-67° C.
27. 1-(7-Thiomethyl-1,2,3,4-tetrahydro-1-naphthalenyl)-4-methylpiperazine; ¹H-NMR (CDCl₃): δ [ppm]=7.7 (s), 7.1 (m), 7.0 (m), 3.9 (m), 2.8 (m), 2.6 (m), 2.6 (s), 2.5 (s), 2.0 (m), 1.7 (m).
28. 1-(7-Ethyl-1,2,3,4-tetrahydro-1-naphthalenyl)-4-methylpiperazine; ¹H-NMR (CDCl₃): δ [ppm]=7.6 (s), 7.0 (m), 3.9 (m), 2.8 (rm), 2.7 (q), 2.5 (m), 2.4 (s), 2.0 (m), 1.7 (m), 1.3 (t).
29. 1-(6-Chloro-1,2,3,4-tetrahydro-1-naphthalenyl)-4-methylpiperazine; ¹H-NMR (CDCl₃): δ [ppm]=7.7 (d), 7.2 (d), 7.1 (s), 3.7 (m), 2.5 (m), 2.3 (s), 2.0 (m), 1.7 (m).
30. 1-(3,4-Dihydro-2H-chromen-4-yl)-4-methylpiperazine; MS: m/z [M+H]⁺=233.
31. 1-(2,3,4,5-Tetrahydro-1-benzothiepin-5-yl)-4-methylpiperazine; MS: m/z [M+H]⁺=263.
32. 1-(7-Tetrafluorethoxy-1,2,3,4-tetrahydro-1-naphthalenyl)-4-methylpiperazine: ¹H-NMR (CDCl₃): δ [ppm]=7.6 (s), 7.0 (d), 6.9 (d), 5.9 (m), 3.9 (m), 2.8 (m), 2.6 (m), 2.4 (s), 2.0 (m), 1.7 (m).
33. 1-(7-Chloro-1,2,3,4-tetrahydro-1-naphthalenyl)-4-methylpiperazine; ¹H-NMR (CDCl₃): δ [ppm]=7.6 (s), 7.2 (d), 7.1 (d), 3.8 (m), 2.7 (m), 2.5 (m), 2.3 10 (s), 2.0 (m), 1.7 (m).
34. 1-(2-Methyl-1-naphthyl)-4-methylpiperazine; MS: m/z [M+H]⁺=243.
35. 1-(8-Chloro-2,3-dihydro-1-benzothiepin-5-yl)-4methylpiperazine; MS: m/z [M+H]⁺=295.
36. 1-(8-Chloro-2,3,4,5-tetrahydro-1-benzothiepin-5-yl)-4-methylpiperazine; MS: m/z [M+H]⁺=297.
37. 1-(7-Fluoro-2,3,4,5-tetrahydro-1-benzothiepin-5-yl)-4-methylpiperazine; MS: m/z [M+H]⁺=281.
38. 1-(7-Fluoro-2,3-dihydro-1-benzothiepin-5-yl)-4-methylpiperazine; MS: m/z [M+H]⁺=279.
39. 1-(6-Methyl-3,4-dihydro-2H-thiochromen-4yl))-4-methylpiperazine; MS: m/z [M+H]⁺=263.
40. 1-(7-Chloro-3,4-dihydro-2H-thiochromen-4-yl)-4-methylpiperazine; MS: m/z [M+H]⁺=283.
41. 1-(4-Methyl-1-naphthyl)-4-methylpiperazine; ¹H-NMR (CDCl₃): δ [ppM]=8.3 (d), 8.0 (d), 7.5 (m), 7.3 (d), 7.0 (d), 3.2 (m), 2.7 (m), 2.6 (s), 2.4 (s).
42. 1-(2-naphthyl)-4-methylpiperazine; ¹H-NMR (CDCl₃): δ [ppm]=7.8 (m), 7.4 (t), 7.2 (m), 7.1 (s), 3.3 (m), 2.6 (m), 2.4 (s).
40 43. 1-(4-Methyl-2quinolinyl)-4-methylpiperazine; MS: m/z [M+H]⁺=242.
44. 1-(5,6,7,8-tetrahydro-1-naphthyl)-piperazine; ¹H-NMR (CDCl₃): δ [ppm]=7.1 (t), 6.9 (m), 3.6 (t), 3.0 (m), 2.9 (m), 2.8 (m).
45. 1-(7-Methoxy-1-naphthyl)-4-methylpiperazine; ¹H-NMR (CDCl₃): δ [ppm]=7.8 (d), 7.6 (m), 7.3 (m), 7.2 (m), 4.0 (s), 3.2 (m), 2.8 (m), 2.5 (s).
46. 1-(7-Ethyl-1-naphthyl)-4-methylpiperazine; ¹H-NMR (CDCl₃): δ [ppm]=8.0 (s), 7.8 (d), 7.5 (d), 7.4 (m), 7.3 (m), 7.2 (m), 2.9 (m), 2.7(m), 2.4 (s), 1.3 (t).
47. 1-(6-Chloro-2,3-dihydro-9H-inden-1-yl)-4-methylpiperazine; ¹H-NMR (CDCl₃): δ [ppm]=7.3 (s), 7.2 (m), 7.1 (d), 7.1 (d), 4.3 (m), 2.9 (m), 2.8 (m), 2.6 (m), 2.5 (m), 2.4 (s), 2.2 (m).
48. 1-(6-Methyl-2,3-dihydro-1H-inden-1-yl)-4-methylpiperazine; ¹H-NMR (CDCl₃): δ [ppm]=7.2 (s), 7.1 (d), 7.0 (d), 4.3 (m), 2.9 (m), 2.8 (m), 2.7 (m), 2.6 (m), 2.5 (m), 2.3 (s), 2.3 (s), 2.1 (m).
49. 1-(2-Fluoro-6,7,8,9-tetrahydro-5H-benzo[a]cyclohepten-5-yl)-4-methylpiperazine; ¹H-NMR (CDCl₃): δ [ppm]=7.0 (m), 6.8 (m), 3.5 (t), 2.5 (m), 2.3 (s), ?.2 (m), 2.1 (m), 2.0 (m), 1.7 (m), 1.6 (m), 1.4 (m).
50. 1-(4-Chloro-1-naphthyl)-4-methylpiperazine; mp.=216-217° C.
51. Cis,trans-1-[3-phenyl-2,3-dihydro-1H-inden-1-yl]-4-methylpiperazine; ¹H-NMR (CDCl₃): δ [ppm]=7.5 (m), 7.4 (m), 7.3 (m), 7.2 (m), 6.9 (d), 4.5 (m), 4.2 (m), 3.8 (m), 2.8 (m), 2.6 (m), 2.5 (s), 2.0 (m).
52. 1-[5-Fluoro-1-phenyl-1H-inden-3-yl]-4-methylpiperazine; MS: m/z [M+H]⁺=309.
53. Cis,trans-1-[6-Fluoro-3-phenyl-2,3-dihydro-1H-inden-1-yl]-4-methylpiperazine; ¹H-NMR (CDCl₃): δ [ppm]=7.5 (m), 7.3 (m), 7.2 (m), 7.1 (m), 7.0 (m), 4.5 (m), 4.2 (m), 3.0 (m), 2.8 (m), 2.6 (m), 2.4 (d), 2.0 (m).
54. Cis,trans-1-[1-(4-chlorophenyl)-5-methyl-1H-inden-3-yl]-4-methylpiperazine; mp.=133-135° C.
55. Cis trans-1-[3-(4-fluorophenyl)-6-fluoro-2,3-dihydro-1H-inden-1-yl]4-methylpiperazine; ¹H-NMR (CDCl₃): δ [ppm]=7.3 (s), 7.2 (m), 7.0 (m), 6.9 (m), 6.8 (m), 4.4 (m), 4.2 (m), 2.8 (m), 2.7 (m), 2.6 (m), 2.3 (d), 2.0 (m).
56. Cis,trans-1-[6-Chloro-3-isopropyl-2,3-dihydro-1H-inden-1-yl]-4-methylpiperazine; ¹H-NMR (CDCl₃): δ [ppm]=7.3 (d), 7.2 (d), 7.1 (d), 4.4 (m), 4.3 (m), 3.2 (m), 3.0 (m), 2.4 (d), 2.2 (m), 2.0 (m), 1.9 (m), 1.0 (d), 1.0 (d), 0.8 (t).
57. Cis,trans-1-[3-(4-fluorophenyl)-5-fluoro-2,3-dihydro-1H-inden-1-yl]4-methylpiperazine; ¹H-NMR (CDCl₃): δ [ppm]=7.4 (m), 7.3 (m), 7.1 (m), 7.0 (m), 6.9 (m), 6.7 (d), 6.6 (d), 4.4 (m), 4.2 (m), 2.8 (m), 2.7 (m), 2.6 (m), 2.4 (d), 2.0 (m).
58. Cis,trans-1-[3-(2-fluorophenyl)-6-fluoro-2,3-dihydro-1H-inden-1-yl]4-methylpiperazine; ¹H-NMR (CDCl₃): δ [ppm]=7.2 (m), 7.1 (m), 7.0 (m), 6.9 (m),6.8 (m), 4.5 (m), 2.7 (m), 2.6 (m), 2.5 (m), 2.3 (s), 2.1 (m).
59. Cis,trans-1-[3-(4-fluorophenyl)-6-thiomethyl-2,3-dihydro-1H-inden-1-y]-4-methylpiperazine; ¹H-NMR (CDCl₃): δ [ppm]=7.3 (s), 7.1 (m), 7.0 (m), 6.9 (d), 6.8 (d), 4.4 (m), 4.2 (m), 2.7 (m), 2.5 (m), 2.5 (s), 2.4 (d), 2.0 (m).
60. Cis,trans-1-[3-(3-fluorophenyl)-5-fluoro-2,3-dihydro-1H-inden-1-yl]-4-methylpiperazine; ¹H-NMR (CDCl₃): δ [ppm]=7.4 (m), 7.3 (m), 7.0 (m), 6.9 (m), 6.8 (d), 6.7 (d), 6.6 (d), 4.4 (m), 4.2 (m), 2.8 (m), 2.7 (m), 2.6 (m), 2.5 (m), 2.3 (d), 2.0 (m).
61. Trans-1-[3-(4-fluorophenyl)-6-chloro-2,3-dihydro-1H-inden-1-yl]4-methylpiperazine.

Use examples of action against plant, structural and human health pests

The action of the compounds of the formula I against pests was demonstrated by the following experiments:

A): Nematicidal evaluation

### Example 1

Test Procedures for Root-knot Nematode Solution Assay (Meloidogyne incognita)

To microtiter plates containing about 1.0 mg of the active compound, 80:20 acetone:water was added to each well and the solution was mixed to obtain the desired compound concentration. The aqueous nematode suspension containing 20 to 50 Meloidogyne incognita J2 larvae per 50 ml was added to each plate. The plates were then sealed and they were placed in an incubator at 27° C. and about 50% relative humidity. After 72 hours, the population mortality was read, whereby immobility of nematodes was regarded as mortality.

### Example 2

Test Procedures for Soybean Cyst Nematode Solution Assay (Heterodera glycine)

To microfiter plates containing about 150 mg of compound, 80:20 acetone was added to each well and the solution was mixed to obtain the desired compound concentration. The nematode suspension of J2 Heterodera glycines larvae was added to the plate. The plates were then sealed and placed in an incubator at 27° C. and about 50% relative humidity. After 72 hours, the population mortality was read, whereby immobility of nematodes was regarded as mortality.

B): Activity against insects and arachnids

### Example 3

Cotton Aphid (aphis gossypii)

The active compounds were formulated in 50:50 acetone:water and 100 ppm Kinetic® surfactant (a nonionic wetting agent which is a blend of polyalkyleneoxide modified polydimethylsiloxane and polyoxypropylene-polyoxyethylene copolymers, available from Helena Chemical Company, Memphis, Tenn. 38119, U.S.A.).

Cotton plants at the cotyledon stage (one plant per pot) were infested by placing a heavily infested leaf from the main colony on top of each cotyledon. The aphids were allowed to transfer to the host plant overnight, and the leaf used to transfer the aphids was removed. The cotyledons were dipped in the test solution and allowed to dry. After 5 days, mortality counts were made.

In this test, compounds 16, 20, 53 and 61 at 300 ppm showed over 85% mortality in comparison with untreated controls.

### Example 4

Green Peach Aphid (myzus persicae)

The active compounds were formulated in 50:50 acetone:water and 100 ppm Kinetic® surfactant.

Pepper plants in the 2^{nd} leaf-pair stage (variety ‘California Wonder’) were infested with approximately 40 laboratory-reared aphids by placing infested leaf sections on top of the test plants. The leaf sections were removed after 24 hours. The leaves of the intact plants were dipped into gradient solutions of the test compound and allowed to dry. Test plants were maintained under fluorescent light (24 hour photoperiod) at about 25° C. and 2040% relative humidity. Aphid mortality on the treated plants, relative to mortality on check plants, was determined after 5 days.

In this test, compounds 5, 16, 20, 53 and 61 at 300 ppm showed over 85% mortality in comparison with untreated controls.

### Example 5

Bean Aphid (Aphis fabae)

Nasturtium plants in the 1^{st} leaf-pair stage (variety ‘Mixed Jewle’ were infested with approximately 25 laboratory-reared aphids by placing infested cut plants on top of the test plants. The cut plants were removed after 24 hours. The foliage and stem of the test plants were dipped into gradient solutions of the test compound. Aphid mortality was determined after 3 days.

In this test, compounds 16 at 300 ppm showed over 70% mortality compared to untreated controls.

### Example 6

Silverleaf whitefly (bemisia argentifolii)

The active compounds were formulated in 50:50 acetone:water and 100 ppm Kinetic® surfactant.

Selected cotton plants were grown to the cotyledon state (one plant per pot). The cotyledons were dipped into the test solution to provide complete coverage of the foliage and placed in a well-vented area to dry. Each pot with treated seedling was placed in a plastic cup and 10 to 12 whitefly adults (approximately 3-5 day old) were introduced. The cups were covered with a re-usable screened lid (150 micron mesh polyester screen PeCap from Tetko Inc). Test plants were maintained in the holding room at about 25° C. and 20-40% relative humidity for 3 days avoiding direct exposure to the fluorescent light (24 hour photoperiod) to prevent trapping of heat inside the cup.

Mortality was assessed 3 days after treatment of the plants.

In this test, compound 20 at 300 ppm showed over 95% mortality compared to untreated controls.

### Example 7

Yellowfever mosquitos (aedes aegypti)

The test compound (1 Vol % in acetone) was applied to water in glass dishes containing 4th instar aedes aegypti. The test dishes were maintained at about 25° C. and observed daily for mortality. Each test was replicated in 3 test dishes.

### Example 8

Orchid Thrips (dichromothrips corbetti)

The test compound was diluted to a concentration of 500 ppm in a 1:1 mixture of acetone:water plus 0.01% Kinetic® surfactant.

Thrips potency was evaluated by using a floral-immersion technique. Plastic petri dishes were used as test arenas. All petals of individual orchid flowers were dipped into the treatment solution for approximately 3 seconds and allowed to dry for 2 hours. Treated flowers were placed into individual petri dishes along with 10-15 adult thrips. The petri dishes were covered with lids and held under continuous light and a temperature of about 28° C. for 4 days. The numbers of live thrips were counted on each flower, and along inner walls of each petri dish. The level of thrips mortality was extrapolated from pre-treatment thrips numbers.

### Example 9

Twospotted Spider Mite (Tetranychus urticae)

Lima bean plants in the 1^{st} leaf-pair stage (variety ‘Henderson’) were infested with approximately 100 laboratory-reared mites per leaf by placing infested leaf sections on top of the test plants. The leaf sections were removed after 24 hours. The foliage of the intact plants was dipped into gradient solutions of the test compounds. Mite mortality was determined after 5 days.

In this test, compounds 12, 14, 20 and 21 at 300 ppm showed over 70% mortality compared to untreated controls.

1-3. (canceled)

4. A method for combatting insects, arachnids or nematodes comprising contacting an insect, arachnid or nematode with a pesticidally effective amount of at least one compound of formula I 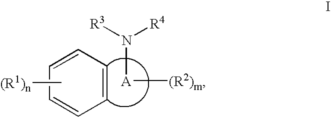
wherein
A is a 5- to 7-membered ring which, in addition to carbon atoms, may contain 1-3 heteroatoms, each selected from the group oxygen, sulfur and nitrogen, and which may be saturated or partially or completely unsaturated;
R¹ is hydroxy, mercapto, amino, cyano, nitro, halogen, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₂-C₆-alkenyl, C₂-C₆-alkenyloxy, C₂-C₆-alkenylthio, C₂-C₆-alkynyl, C₂-C₆-alkynyloxy, C₂-C₆-alkynylthio, C₁-C₆-alkylsulfonyl, C₁-C₆-alkylsulfoxyl, C₂-C₆-alkenylsulfonyl, C₂-C₆-alkynylsulfoxyl, (C₁-C₆-alkyl)carbonyl, (C₁-C₆-alkoxy)carbonyl or (C₁-C₆-alkyl)carbonyloxy;
R² is a mono- or bicyclic 5- to 10-membered aromatic ringsystem which may contain 1 to 4 heteroatoms and which is either bonded directly or through an oxygen, sulfur, C₁-C₆-alkylene or C₁-C₆-alkyleneoxy linkage to A, and which is unsubstituted or substituted with any combination of 1 to 3 substituents, each selected from the group consisting of cyano, nitro, hydroxy, mercapto, amino, carboxyl, halogen, C₁-C₆-alkyl, C₁-C₆-haloalkyl, C₁-C₆-alkoxy, C₂-C₆-alkenyloxy, C₂-C₆-alkynyl-oxy, C₁-C₆-haloalkoxy, C₁-C₆-alkylthio or C₁-C₆-haloalkylthio;
R³ and R⁴ together with the nitrogen atom to which they are attached form a saturated or partially saturated mono- or bicyclic 5- to 10-membered ringsystem containing 1 to 3 heteroatoms selected from nitrogen and oxygen or 5-membered hetaryl containing 1 to 4 nitrogen atoms, wherein the carbon and/or nitrogen atoms in the saturated, partially saturated or aromatic rings are unsubstituted or substituted with any combination of 1 to 4 groups selected from amino, C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-alkylthio, C₂-C₆-alkenylthio, C₂-C₆-alkynylthio, C₁-C₆-alkylamino, di(C₁-C₆-alkyl)amino, C₂-C₆-alkenylamino, C₂-C₆-alkynylamino, C₁-C₆-hydroxyalkyl, hydroxycarbonyl-C₁-C₄-alkyl, (C₁-C₆-alkoxy)carbonyl-C₁-C₄-alkyl, (C₁-C₆-alkyl)carbonyl-C₁-C₄-alkoxy, C₃-C₆-cycloalkyl, which is bonded directly or via C₁-C₆-alkyl linkage, and C₅-C₈-cycloalkenyl or phenyl or benzyl which may be substituted by cyano, nitro, hydroxy, mercapto, amino, carboxyl, halogen, C₁-C₆-alkyl, C₁-C₆-haloalkyl, C₁-C₆-alkoxy, C₂-C₆-alkenyloxy, C₂-C₆-alkynyloxy, C₁-C₆-haloalkoxy, C₁-C₆-alkylthio or C₁-C₆-haloalkylthio; or
R³ and R⁴ together form the chains —(CH₂)₂N⁺(O⁻)(CH₂)₂- or —(CH₂)₃N⁺(O⁻)(CH₂)₂—;
m is 0, 1, 2, 3 or 4;
n is 0, 1, 2, 3 or 4;
or the enantiomers, diastereomers, cis/trans isomers or salts thereof.

5. A method for controlling insects, arachnids or nematodes comprising contacting the food supply, habitat or breeding ground(s) of an insect, arachnid or nematode with a pesticidally effective amount of at least one compound of formula I 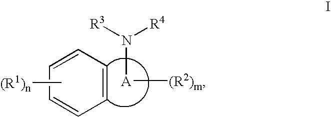
wherein
A is a 5- to 7-membered ring which, in addition to carbon atoms, may contain 1-3 heteroatoms, each selected from the group oxygen, sulfur and nitrogen, and which may be saturated or partially or completely unsaturated;
R¹ is hydroxy, mercapto, amino, cyano, nitro, halogen, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₂-C₆-alkenyl, C₂-C₆-alkenyloxy, C₂-C₆-alkenylthio, C₂-C₆-alkynyl, C₂-C₆-alkynyloxy, C₂-C₆-alkynylthio, C₁-C₆-alkylsulfonyl, C₁-C₆-alkylsulfoxyl, C₂-C₆-alkenylsulfonyl, C₂-C₆-alkynylsulfoxyl, (C₁-C₆-alkyl)carbonyl, (C₁-C₆-alkoxy)carbonyl or (C₁-C₆-alkyl)carbonyloxy;
R² is a mono- or bicyclic 5- to 10-membered aromatic ringsystem which may contain 1 to 4 heteroatoms and which is either bonded directly or through an oxygen, sulfur, C₁-C₆-alkylene or C₁-C₆-alkyleneoxy linkage to A, and which is unsubstituted or substituted with any combination of 1 to 3 substituents, each selected from the group consisting of cyano, nitro, hydroxy, mercapto, amino, carboxyl, halogen, C₁-C₆-alkyl, C₁-C₆-haloalkyl, C₁-C₆-alkoxy, C₂-C₆-alkenyloxy, C₂-C₆-alkynyl-oxy, C₁-C₆-haloalkoxy, C₁-C₆-alkylthio or C₁-C₆-haloalkylthio;
R³ and R⁴ together with the nitrogen atom to which they are attached form a saturated or partially saturated mono- or bicyclic 5- to 10-membered ringsystem containing 1 to 3 heteroatoms selected from nitrogen and oxygen or 5-membered hetaryl containing 1 to 4 nitrogen atoms, wherein the carbon and/or nitrogen atoms in the saturated, partially saturated or aromatic rings are unsubstituted or substituted with any combination of 1 to 4 groups selected from amino, C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-alkylthio, C₂-C₆-alkenylthio, C₂-C₆-alkynylthio, C₁-C₆-alkylamino, di(C₁-C₆-alkyl)amino, C₂-C₆-alkenylamino, C₂-C₆-alkynylamino, C₁-C₆-hydroxyalkyl, hydroxycarbonyl-Cl -C₄-alkyl, (C₁-C₆-alkoxy)carbonyl-C₁-C₄-alkyl, (C₁-C₆-alkyl)carbonyl-C₁-C₄-alkoxy, C₃-C₆-cycloalkyl, which is bonded directly or via C₁-C₆-alkyl linkage, and C₅-C₈-cycloalkenyl or phenyl or benzyl which may be substituted by cyano, nitro, hydroxy, mercapto, amino, carboxyl, halogen, C₁-C₆-alkyl, C₁-C₆-haloalkyl, C₁-C₆-alkoxy, C₂-C₆-alkenyloxy, C₂-C₆-alkynyloxy, C₁-C₆-haloalkoxy, C₁-C₆-alkylthio or C₁-C₆-haloalkylthio; or
R³ and R⁴ together form the chains —(CH₂)₂N⁺(O⁻)(CH₂)₂— or —(CH₂)₃N⁺(O⁻)(CH₂)₂—;
m is 0, 1, 2, 3 or 4;
n is 0, 1, 2, 3 or 4;
or an enantiomer, diastereomer, cis/trans isomer or salt thereof.

6. A method for protecting growing plants from attack or infestation by insects, arachnids or nematodes comprising contacting a plant, or soil or water in which the plant is growing, with a pesticidally effective amount of at least one compound of formula I, 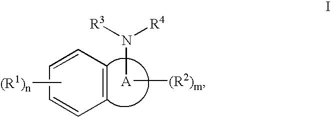
wherein
A is a 5- to 7-membered ring which, in addition to carbon atoms, may contain 1-3 heteroatoms, each selected from the group oxygen, sulfur and nitrogen, and which may be saturated or partially or completely unsaturated;
R¹ is hydroxy, mercapto, amino, cyano, nitro, halogen, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₂-C₆-alkenyl, C₂-C₆-alkenyloxy, C₂-C₆-alkenylthio, C₂-C₆-alkynyl, C₂-C₆-alkynyloxy, C₂-C₆-alkynylthio, C₁-C₆-alkylsulfonyl, C₁-C₆-alkylsulfoxyl, C₂-C₆-alkenylsulfonyl, C₂-C₆-alkynylsulfoxyl, (C₁-C₆-alkyl)carbonyl, (C₁-C₆-alkoxy)carbonyl or (C₁-C₆-alkyl)carbonyloxy;
R² is a mono- or bicyclic 5- to 10-membered aromatic ringsystem which may contain 1 to 4 heteroatoms and which is either bonded directly or through an oxygen, sulfur, C₁-C₆-alkylene or C₁-C₆-alkyleneoxy linkage to A, and which is unsubstituted or substituted with any combination of 1 to 3 substituents, each selected from the group consisting of cyano, nitro, hydroxy, mercapto, amino, carboxyl, halogen, C₁-C₆-alkyl, C₁-C₆-haloalkyl, C₁-C₆-alkoxy, C₂-C₆-alkenyloxy, C₂-C₆-alkynyl-oxy, C₁-C₆-haloalkoxy, C₁-C₆-alkylthio or C₁-C₆-haloalkylthio;
R³ and R⁴ together with the nitrogen atom to which they are attached form a saturated or partially saturated mono- or bicyclic 5- to 10-membered ringsystem containing 1 to 3 heteroatoms selected from nitrogen and oxygen or 5-membered hetaryl containing 1 to 4 nitrogen atoms, wherein the carbon and/or nitrogen atoms in the saturated, partially saturated or aromatic rings are unsubstituted or substituted with any combination of 1 to 4 groups selected from amino, C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-alkylthio, C₂-C₆-alkenylthio, C₂-C₆-alkynylthio, C₁-C₆-alkylamino, di(C₁-C₆-alkyl)amino, C₂-C₆-alkenylamino, C₂-C₆-alkynylamino, C₁-C₆-hydroxyalkyl, hydroxycarbonyl-C₁-C₄-alkyl, (C₁-C₆-alkoxy)carbonyl-C₁-C₄-alkyl, (C₁-C₆-alkyl)carbonyl-C₁-C₄-alkoxy, C₃-C₆-cycloalkyl, which is bonded directly or via C₁-C₆-alkyl linkage, and C₅-C₈-cycloalkenyl or phenyl or benzyl which may be substituted by cyano, nitro, hydroxy, mercapto, amino, carboxyl, halogen, C₁-C₆-alkyl, C₁-C₆-haloalkyl, C₁-C₆-alkoxy, C₂-C₆-alkenyloxy, C₂-C₆-alkynyloxy, C₁-C₆-haloalkoxy, C₁-C₆-alkylthio or C₁-C₆-haloalkylthio; or
R³ and R⁴ together form the chains —(CH₂)₂N⁺(O⁻)(CH₂)₂— or —(CH₂)₃N⁺(O⁻)(CH₂)₂—;
m is 0, 1, 2, 3 or 4;
n is 0, 1, 2, 3 or 4;
or an enantiomer, diastereomer, cis/trans isomer or salt thereof.
